(19) United States
(12) Patent Application Publication
(10) Pub. No.: US 2013/0205205 A1
(43) Pub. Date: Aug. 8, 2013

(54) Simplified Text Formatting Using Domain Specific Heuristics

(71) Applicants: John Paul Powers, Garland, TX (US); Peter Rajcani, Plano, TX (US)

(72) Inventors: John Paul Powers, Garland, TX (US); Peter Rajcani, Plano, TX (US)

(21) Appl. No.: 13/366,107

(22) Filed: Feb. 3, 2012

(51) Int. Cl. G06F 17/00

(52) U.S. Cl. 715/269

(57) ABSTRACT

A method for text formatting on a digital system is provided that includes activating a domain specific input mode responsive to user input, receiving input characters typed by the user while the domain specific input mode is activated, and displaying the input characters according to formatting rules specific to the domain.

### BACKGROUND OF THE INVENTION

### 1. Field of the Invention

Embodiments of the present invention generally relate to simplified text formatting using domain specific heuristics.

2. Description of the Related Art

Entering text and formulas containing many special characters and atypical formatting is cumbersome on handheld calculators. A user of a handheld calculator typically has to painstakingly enter and format such text or formulas using text formatting commands such as subscript, superscript, bold, italic, etc. selected from a menu or template. Further, the user typically has to enter any special characters or symbols using a symbol palette or a template. These operations can be cumbersome and slow due to the small, limited keyboard on a handheld calculator. When pressed for a time, the user will often avoid performing the needed formatting and special character entry.

For example, students and teachers in a chemistry class have limited time during a class session and do not want to waste time polishing the format of chemical formulas typed on a handheld calculator. Chemical formulas contain superscripted and subscripted digits and other special symbols which make the formula cumbersome to type and format correctly. Often the students and teachers skip typing the conventional notation of chemical equations because of the time pressures of lecture note-taking or exposition.

### SUMMARY

Embodiments of the present invention relate to simplified text formatting using domain specific heuristics. In one aspect, a method for text formatting on a digital system includes activating a domain specific input mode responsive to user input, receiving input characters typed by the user while the domain specific input mode is activated, and displaying the input characters according to formatting rules specific to the domain.

In one aspect, a method for automatic formatting of a chemical formula on a handheld calculator includes activating a chemistry input mode on the handheld calculator response to user input, receiving input characters of a chemical equation typed by the user while the chemistry input mode is activated, and displaying the input characters according to formatting rules corresponding to conventions for chemical formulas.

In one aspect, a digital system includes a display, an input device, a memory, and a processor coupled to the display, the input device, and the memory, wherein the processor is configured to execute software instructions stored in the memory, wherein the software instructions are configured to activate a domain specific input mode responsive to user input, receive input characters typed by the user while the domain specific input mode is activated, and display the input characters according to formatting rules specific to the domain.

### BRIEF DESCRIPTION OF THE DRAWINGS

Particular embodiments in accordance with the invention will now be described, by way of example, and with reference to the accompanying drawings:

FIG. 1 shows an example of a calculator;

FIG. 2 is a block diagram of the calculator of FIG. 1;

FIG. 3 is a block diagram of an example computer system;

FIG. 4 is a state diagram for text formatting in a chemistry domain; and

FIG. 5 is a flow diagram of a method for text formatting using domain specific heuristics.

### DETAILED DESCRIPTION OF EMBODIMENTS OF THE INVENTION

Specific example embodiments of the invention will now be described in detail with reference to the accompanying figures. Like elements in the various figures are denoted by like reference numerals for consistency.

As was previously mentioned, entering text and formulas containing many special characters and atypical formatting is cumbersome on handheld calculators. Embodiments of the invention provide quick and easy entry of formatted text in domains where the rules for formatting and the special characters needed to display the text are well established. A special input mode tailored to each specific domain is employed that uses a domain-specific algorithm to determine the formatting of characters as a user types the characters. That is, the input mode for a domain understands text formatting conventions of the domain and automatically formats text according to those conventions without requiring the user to enter text formatting commands such as, for example, subscript, superscript, bold, italics, etc. In some embodiments, common character inputs are also automatically converted to special characters used in the particular domain. For example, in an embodiment for the chemistry domain, an “=” character is automatically converted to the chemical production symbol “→”. Thus, domain specific text can be entered without resorting to formatting commands, templates, palettes, and the like.

In an example embodiment, a chemistry domain input mode automatically determines which characters should be superscripted and which should be subscripted. More specifically, a user instructs a text editor to enter chemistry mode at the current location of the input cursor. Any text typed while in chemistry mode is interpreted as a chemical formula. The chemistry mode operates according to conventions for formatting chemical equations to properly raise or lower characters to superscripts and subscripts. The chemistry mode may also automatically add spaces to improve readability of the formula, and/or automatically display special symbols used in chemical formulas, e.g., display the chemical production symbol (→) when the user types the equal sign. The chemistry mode may also automatically perform appropriate capitalization for most chemical element symbols.

For illustrative purposes, embodiments may be described herein with reference to the TI-Nspire™ handheld graphing calculators and the TI-Nspire™ software available from Texas Instruments. One of ordinary skill in the art will appreciate that embodiments are not limited to the TI-Nspire™ calculator and TI-Nspire™ software.

A handheld calculator such as the TI-Nspire™ is capable of generating and operating on one or more documents. In the TI-Nspire™ environment, a document may include one or multiple problems. Each problem may contain multiple pages. Further, each page may be divided into multiple work areas and each work area may contain any of the TI-Nspire™ applications, e.g., Calculator, Graph, Geometry, Lists & Spreadsheet, Data & Statistics, and Notes. An application may be added to a document, for example, by selecting a corresponding application icon in a menu. The Notes application provides functionality for, among other things, adding and formatting text in a document and the insertion of mathematical expressions. This latter functionality is referred to as a math box or math expression box. As is explained in more detail herein, in some embodiments, functionality for insertion of chemical formulas in a document is provided as part of the Notes application in the form of a chemistry box. Adding a chemistry box to a document via the Notes application activates a chemistry domain input mode in which characters typed into the chemistry box are automatically formatted into well-formed chemical equations without requiring the user to use text formatting commands.

The TI-Nspire™ software executes on a computer system and enables users to perform the same functions on a computer system that can be performed on a TI-Nspire™ calculator, i.e., the software emulates the calculator operation. Documents generated using the TI-Nspire™ software can be used on a TI-Nspire™ calculator and vice versa. In some embodiments, functionality for insertion of chemical formulas in a document is provided as part of the Notes application in the form of a chemistry box. Student and teacher versions of the TI-Nspire™ software are described in “TI-nspire™ Student Software Guidebook”, Texas Instruments Incorporated, 2006-2011, and “TI-nspire™ Teacher Software Guidebook”, Texas Instruments Incorporated, 2006-2011, which are incorporated by reference herein. These documents also describe the operation of the software on the TI-Nspire™ calculator.

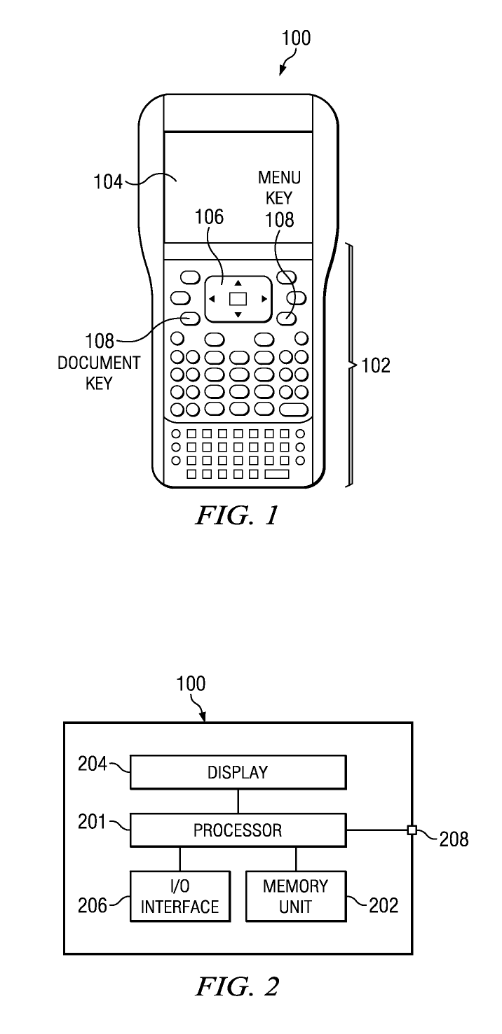

FIG. 1 shows an example embodiment of a handheld calculator 100. For illustrative purposes, the handheld calculator illustrated in FIG. 1 is similar to graphing calculators available from Texas Instruments Inc. Handheld calculators with more or fewer components may be used in other embodiments. As shown in FIG. 1, the handheld calculator 100 includes a graphical display 104, and a keypad 102 that includes a touchpad 106 and special function keys such as a menu key 108 and a document key 108. The graphical display 104 may be used to display, among other things, information input to applications executing on the handheld calculator 100 and various outputs of the applications. The graphical display 104 may be, for example, an LCD display. The keypad 102 allows a user, e.g., a student or instructor, to enter data and functions and to start and interact with applications executing on the handheld calculator 100. The keypad 102 also includes an alphabetic keyboard for entering text. The menu key 108 on the keypad 102 activates menus associated with applications executing on the handheld calculator 100 and the document key 108 opens a new document with a notes page, e.g., a Notes application, or adds a notes page to an open document. The touchpad 106 allows a user to interact with the display 104 by translating the motion and position of the user's fingers on the touchpad 106 to provide functionality similar to using an external pointing device, e.g., a mouse. A user may use the touchpad 106 to perform operations similar to using a pointing device on a computer system, e.g., scrolling the display 104 content, pointer positioning, selecting, highlighting, etc.

FIG. 2 is a block diagram of the handheld calculator 100. The handheld calculator 100 includes a processor 201 coupled to a memory unit 202, which may include one or both of read-only memory (ROM) and random-access memory (RAM). In some embodiments, the ROM stores software programs implementing functionality described herein and the RAM stores intermediate data and operating results. An input/output port 208 provides connectivity to external devices, e.g., a hub that is coupled to other handheld calculators and/or a classroom computer. The input/output port 208 may be a bi-directional connection such as a mini-A USB port. Also included in the handheld calculator 100 are a display interface 204 and an I/O interface 206. The I/O interface 206 provides an interface to couple input devices such as the touchpad 106 and the keypad 102 to the processor 201. In some embodiments, the handheld calculator 100 may also include an integrated wireless interface (not shown) or a port for connecting an external wireless interface (not shown).

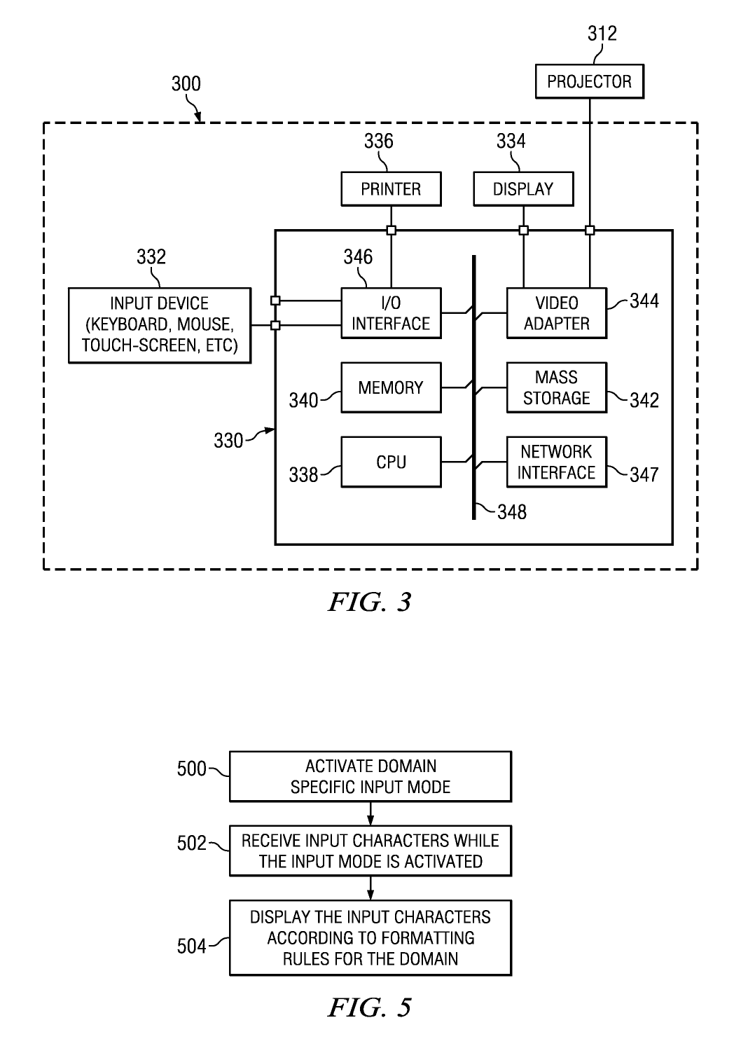

FIG. 3 is a block diagram of an example embodiment of a computer system 300. The computer system 300 includes a processing unit 330 equipped with one or more input devices 332 (e.g., a mouse, a keyboard, or the like), and one or more output devices, such as a display 334, a printer 336, or the like. In some embodiments, the display 334 may be touch screen, thus allowing the display 334 to also function as an input device. The processing unit 330 may be, for example, a desktop computer, a workstation, a laptop computer, a dedicated unit customized for a particular application, or the like. The display may be any suitable visual display unit such as, for example, a computer monitor, an LED, LCD, or plasma display, a television, a high definition television, or a combination thereof.

The processing unit 330 includes a central processing unit (CPU) 338, memory 340, a mass storage device 342, a video adapter 344, and an I/O interface 346 connected to a bus 348. The bus 348 may be one or more of any type of several bus architectures including a memory bus or memory controller, a peripheral bus, video bus, or the like. The CPU 338 may be any type of processor. For example, the CPU 338 may be a processor from Intel Corp., a processor from Advanced Micro Devices, Inc., a Reduced Instruction Set Computer (RISC), an Application-Specific Integrated Circuit (ASIC), or the like. The memory 340 may be any type of system memory such as static random access memory (SRAM), dynamic random access memory (DRAM), synchronous DRAM (SDRAM), read-only memory (ROM), a combination thereof, or the like. Further, the memory 340 may include ROM for use at boot-up, and DRAM for data storage for use while executing programs.

The mass storage device 342 (e.g., a computer readable medium) may include any type of storage device configured to store data, programs, and other information and to make the data, programs, and other information accessible via the bus 348. In one or more embodiments, the mass storage device 342 stores software instructions for calculator emulation software to be executed by the CPU 338. The calculator emulation software may include functionality described herein. The mass storage device 342 may be, for example, one or more of a hard disk drive, a magnetic disk drive, an optical disk drive, or the like. The software instructions may be initially stored in a computer-readable medium such as a compact disc (CD), a diskette, a tape, a file, memory, or any other computer readable storage device and loaded and executed by the CPU 338. In some cases, the software may also be sold in a computer program product, which includes the computer-readable medium and packaging materials for the computer-readable medium. In some cases, the software may be distributed to the computer system 300 via removable computer readable media (e.g., floppy disk, optical disk, flash memory, USB key), via a transmission path from computer readable media on another computer system (e.g., a server), etc.

The video adapter 344 and the I/O interface 346 provide interfaces to couple external input and output devices to the processing unit 330. As illustrated in FIG. 3B, examples of input and output devices include the display 334 and a projector 312 coupled to the video adapter 344 and the mouse/keyboard 332 and the printer 336 coupled to the I/O interface 346.

The processing unit 330 also includes a network interface 347. The network interface 347 allows the processing unit 330 to communicate with remote units via a network (not shown). In one or more embodiments, the network interface 347 allows the computer system 300 to communicate via a network to one or more handheld calculators. The network interface 347 may provide an interface for a wired link, such as an Ethernet cable or the like, or a wireless link.

The computer system 300 may also include other components not specifically shown. For example, the computer system 300 may include power supplies, cables, a motherboard, removable storage media, cases, and the like.

In an embodiment, an input mode for the chemistry domain is provided on the calculator 100 and/or as part of calculator emulation software executing on the computer system 300. This input mode is provided in a Notes application and takes the form of a chemical equation box, also referred to as a chem box. To enter a chemical equation or formula on the calculator 100, the user may, for example, activate an insert menu on a notes page using the menu key 108, and select the chem box option from the menu. A chemistry equation box is then placed at the current location of the cursor in the notes page. To enter a chemical equation or formula on the computer system 300, the user may, for example, use a pointing device to activate an insert menu on a notes page, and select the chem box option from the menu.

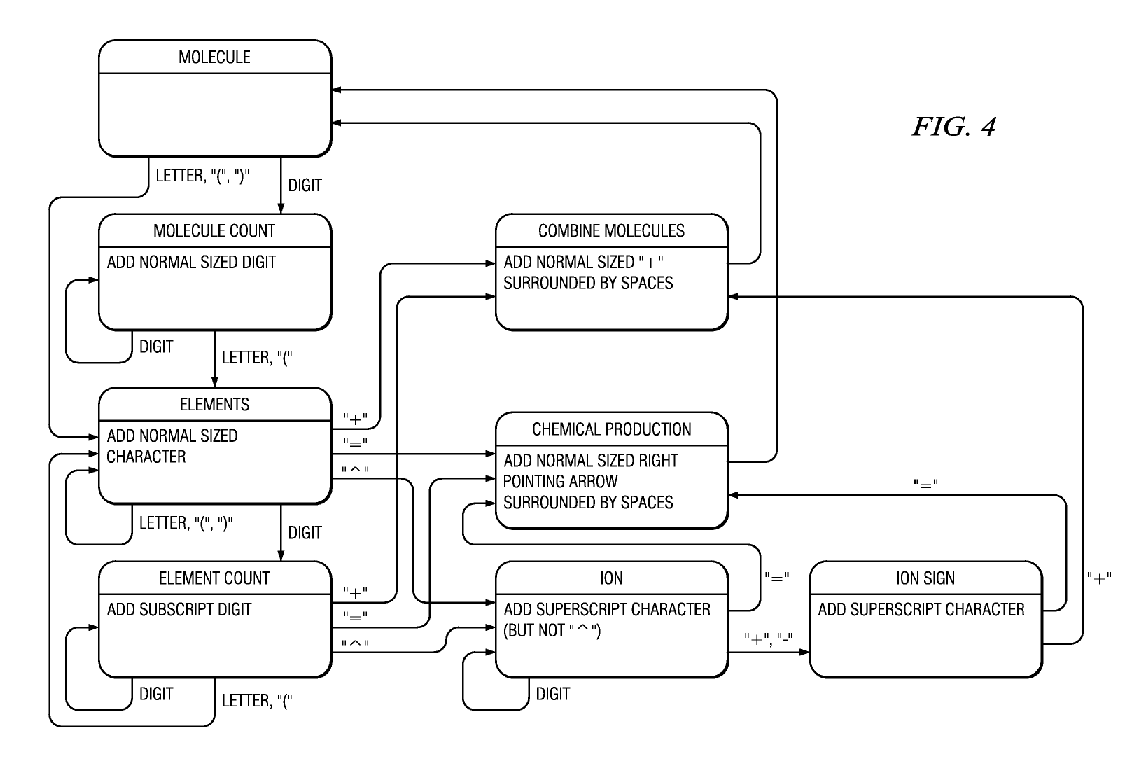

Any text typed in the chemistry equation box is interpreted as a chemical formula. The user may type a chemistry equation in the box adhering to certain rules for entering a chemistry equation, i.e., domain specific rules, and the entered text is automatically displayed in the correct format for a chemistry equation with appropriate superscripting and subscripting. Table 1 contains the input formatting rules. These rules are applied based on the current state of the chemical equation being entered. FIG. 4 shows a state diagram illustrating the application of the rules to format a chemical formula. For example, if a user types 10Î−+16Ĥ++2MnO4̂−=5I2+2Mn̂2++8H2O into a chem box, this input is automatically displayed as 10I⁻+16H⁺+2MnO₄⁻→5I₂+2Mn²⁺+8H₂O as per the state diagram. Error states are not presented in the state diagram of FIG. 4 but will be understood by one of ordinary skill in the art.

TABLE 1

| Rule | Action |
|---|---|
| Leading | Leading numerical digits are treated |
| Digits | as a multiplier for a molecule and are |
| | displayed as regular-sized characters |
| Superscript | A caret “\hat{ }” causes one or more following |
| | characters to be displayed as a |
| | superscript. This is used to indicate ions. |
| | An ion is a minus sign “−” or a plus sign |
| | “+” optionally preceded by an integer. |
| Subscript | An integer immediately following an |
| | alphabetic character or a closing |
| | parenthesis “)” is automatically displayed |
| | as a subscript of the alphabetic |
| | character. This is used to indicate the number |
| | of atoms or groups of atoms in a molecule. |
| Production | The equal “=” character is automatically |
| | converted to the chemical production |
| | symbol “→”, Unicode chracter U + 2192. |
| White | A plus sign “+” between molecules is |
| Space | automatically preceded and followed |
| | by a blank to better set apart the molecules |
| | in the formula. Similarly, the chemical |
| | production symbol “→” is automatically |
| | preceded and followed by a blank. |

In some embodiments, in addition to the rules of Table 1 and the state machine based parsing of input characters of FIG. 4, capitalization is also automatically performed. In such embodiments, if a single lower case alphabetic character is entered, it is automatically displayed in upper case. Further, if two successive lower case alphabetic characters are entered, the first character is automatically displayed in upper case and the second character is displayed in lower case. In addition, the six elements that have three letter symbols are recognized and displayed appropriately with the first character in uppercase and the second two in lower case. This technique for automatic capitalization works for the majority of chemical elements. However, for some two letter elements, e.g., carbon dioxide (CO₂), the user has to manually capitalize the second letter, e.g., the O, to distinguish the element from another element represented by the same two alphabetic characters, e.g., cobalt (Co), in the periodic table.

For example, the user may position the cursor on the calculator 100 on a notes page where a chemical equation is desired. The user may then activate an insert menu and select insertion of a chem box. An empty chemical equation box is then displayed at the cursor position. The user may then represent sulphuric acid by typing h2sO4, capitalizing the O manually. The text is automatically displayed in the chem box as H₂SO₄. For ionic equations, the user may type a caret “̂” and the desired text. For example, the user may type 2mn̂2− and the text is automatically displayed in the chem box as 2Mn²⁻. The user may use parenthesis to indicate whether the compound is a solid (s), a liquid (l), or aqueous (aq). For example, the user may type 2cl̂−(aq)+2aĝ+=2agcl(s) and the text is automatically displayed in the chem box as 2Cl⁻(aq)+2 Ag⁺(aq)→2AgCl(s). The chemical equation box may be exited by selecting a point on the document page outside of the box.

FIG. 5 is a flow diagram of a method for text formatting using domain specific heuristics. Initially, a domain specific input mode is activated 500 by a user. This activation may be performed, for example, by selecting the input mode from a menu or entering specific key strokes on a keypad or keyboard. The domain may be, for example, a chemistry domain. Input characters typed by the user are then received 502 while the domain specific input mode is activated, and the characters are displayed 504 according to formatting rules specific to the domain. Example formatting rules and input state based processing for a chemistry domain are previously described herein.

### Other Embodiments

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

For example, in one embodiment, a domain specific input mode is provided for automatic text formatting of the pronunciation of words. Dictionaries include word pronunciation and sometimes open text phonetically spells out words when the pronunciation is difficult. A pronunciation input mode, e.g., a pronunciation box similar to a chem box, with pronunciation specific text formatting rules, facilitates the in-line formatting of word pronunciation.

Embodiments were described with respect to representative digital systems, i.e., a handheld calculator and a computer executing calculator emulation software. However, embodiments may be useful for other types of digital systems, e.g., laptop computers, desktop computers, handheld computing devices, cellular or mobile telephones. Embodiments may also be implemented in text editing environments other than that of a handheld calculator or calculator emulation software. For example, domain specific text formatting as described herein may be used in general purpose text editors.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

What is claimed is:

1. A method for text formatting on a digital system, the method comprising:
activating a domain specific input mode responsive to user input;
receiving input characters typed by the user while the domain specific input mode is activated; and
displaying the input characters according to formatting rules specific to the domain.

2. The method of claim 1, wherein the domain specific input mode is a chemistry input mode and wherein the formatting rules correspond to chemical formula formatting conventions.

3. The method of claim 2, wherein the formatting rules automatically determine which input characters are to be superscripted and which input characters are to be subscripted when displayed.

4. The method of claim 2, wherein an input character is an equal sign and the formatting rules automatically cause a chemical production symbol to be displayed in place of the equal sign.

5. The method of claim 2, wherein an input character is a caret and the formatting rules automatically cause a next input character to be displayed as a superscript.

6. The method of claim 2, wherein an input character is an integer immediately following one of an alphabetic character and a closing parenthesis and the formatting rules automatically cause the input character to be displayed as a subscript.

7. The method of claim 2, wherein an input character is a lower case alphabetic character and the formatting rules automatically cause the lower case alphabetic character to be displayed as upper case.

8. The method of claim 1, wherein the digital system is a handheld calculator.

9. A method for automatic formatting of a chemical formula on a handheld calculator, the method comprising:
activating a chemistry input mode on the handheld calculator response to user input;
receiving input characters of a chemical equation typed by the user while the chemistry input mode is activated; and
displaying the input characters according to formatting rules corresponding to conventions for chemical formulas.

10. The method of claim 9, wherein an input character is an equal sign and the formatting rules automatically cause a chemical production symbol to be displayed in place of the equal sign.

11. The method of claim 9, wherein an input character is a caret and the formatting rules automatically cause a next input character to be displayed as a superscript.

12. The method of claim 9, wherein an input character is an integer immediately following one of an alphabetic character and a closing parenthesis and the formatting rules automatically cause the input character to be displayed as a subscript.

13. The method of claim 9, wherein an input character is a lower case alphabetic character and the formatting rules automatically cause the lower case alphabetic character to be displayed as upper case.

14. A digital system, comprising:
a display;
an input device;
a memory; and
a processor coupled to the display, the input device, and the memory, wherein the processor is configured to execute software instructions stored in the memory,
wherein the software instructions are configured to:
activate a domain specific input mode responsive to user input;
receive input characters typed by the user while the domain specific input mode is activated; and
display the input characters according to formatting rules specific to the domain.

15. The digital system of claim 14, wherein the domain specific input mode is a chemistry input mode and wherein the formatting rules correspond to chemical formula formatting conventions.

16. The digital system of claim 15, wherein an input character is an equal sign and the formatting rules automatically cause a chemical production symbol to be displayed in place of the equal sign.

17. The digital system of claim 15, wherein an input character is a caret and the formatting rules automatically cause a next input character to be displayed as a superscript.

18. The digital system of claim 15, wherein an input character is an integer immediately following one of an alphabetic character and a closing parenthesis and the formatting rules automatically cause the input character to be displayed as a subscript.

19. The digital system of claim 15, wherein an input character is a lower case alphabetic character and the formatting rules automatically cause the lower case alphabetic character to be displayed as upper case.

20. The digital system of claim 14, wherein the digital system is a handheld calculator.
